(19) United States
(12) Patent Application Publication
(10) Pub. No.: US 2012/0268498 A1
(43) Pub. Date: Oct. 25, 2012

(54) IMAGE DISPLAY CONTROL DEVICE, IMAGE DISPLAY SYSTEM, IMAGE DISPLAY CONTROL METHOD AND COMPUTER PROGRAM

(75) Inventor: Tetsuya HOSHINO, Tokyo (JP)

(73) Assignee: Sony Corporation, Tokyo (JP)

(21) Appl. No.: 13/433,751

(22) Filed: Mar. 29, 2012

(30) Foreign Application Priority Data
Apr. 20, 2011 (JP) 2011-094550

(51) Int. Cl. G09G 5/00

(52) U.S. Cl. 345/672

(57) ABSTRACT

An image display control device includes: an image memory storing image data; a position information management unit managing actual position information of plural displays; an individual image area determination unit determining relative positions at the time of displaying the image data based on actual positions of the plural displays; a unit for detecting target objects included in images; an overlapping degree improvement unit increasing an overlapping degree in which target objects included in the whole image data are included in an overlapping state in respective display areas of the plural displays while maintaining the relative positions; and an individual image data generation unit generating individual image data to be displayed on respective plural displays from the image data in respective display areas of the plural displays in which the overlapping degree has been improved.

### FIELD

The present disclosure relates to an image display control device, an image display system, an image display control method and a computer program displaying images taken by a digital camera and so on, and particularly relates to the image display control device, the image display system, the image display control method and the computer program displaying image data in landscape orientation or in portrait orientation having the size exceeding an original aspect ratio by using plural displays.

### BACKGROUND

A digital photo frame is known as a dedicated information device displaying image data taken by the digital camera. The digital photo frame has an appearance like a photo frame and has conveniences such as a “slide show” function in which plural image data is displayed while being changed at regular time intervals, which has not been provided in related-art photo frames.

The digital cameras in recent times have a function of taking panoramic images in landscape orientation or in portrait orientation having the size exceeding the original aspect ratio. Such panoramic images have the size also exceeding the aspect ratio of the digital photo frame, therefore, only a part of the image is displayed in one digital photo frame. Accordingly, it is possible to think of a method of displaying image data with a large size by allowing plural digital photo frames to work in cooperation with one another.

There has already existed a technique of controlling the display contents by combining plural image display control devices to perform display as a virtual single display, namely, as a multi-display.

For example, there is proposed an image generation device capable of generating an image having consistency at joints in accordance with arrangement of respective screens of the multi-display (for example, see JP-A-2003-209769 (Patent Document 1). However, in the image generation device, the same regions in the same image data are constantly not displayed on non-image display portions other than displays such as frame portions around the displays or spaces between the image display control devices unless the arrangement of the image display control devices or the number of devices is changed. When an object particularly desired to be displayed by a user, for example, a human face or the like overlaps the non-image display portion, the face image is constantly not displayed when the slide-show function is activated.

On the other hand, there is also proposed an image display method in which a region to be displayed on the display is changed so that a human face is not out of frame when image data including the human face and so on is enlarged (for example, see JP-A-2006-227038 (Patent Document 2)). However, the image display method is based on the premise that image data is displayed basically by using a single display, and it is difficult to display the human face overlapping the non-image display portion when displaying image data by using plural displays.

### SUMMARY

In view of the above, it is desirable to provide an excellent an image display control device, an image display system, an image display control method and a computer program capable of suitably displaying image data in landscape orientation or in portrait orientation having the size exceeding an original aspect ratio by using plural displays.

It is also desirable to provide an excellent an image display control device, an image display system, an image display control method and a computer program capable of displaying image data in landscape orientation or in portrait orientation by using plural displays so that an object particularly desired to be displayed by the user such as a human face is displayed without being separated.

An embodiment of the present disclosure is directed to an image display control device including an image memory storing image data, a position information management unit managing actual position information of plural displays, an individual image area determination unit determining relative positions at the time of displaying the image data based on actual positions of the plural displays, a unit for detecting target objects included in images, an overlapping degree improvement unit increasing an overlapping degree in which target objects included in the whole image data are included in an overlapping state in respective display areas of the plural displays while maintaining the relative positions, and an individual image data generation unit generating individual image data to be displayed on respective plural displays from the image data in respective display areas of the plural displays in which the overlapping degree has been improved.

According to the embodiment of the present disclosure, the overlapping degree improvement unit may search for a movement amount in which the number of target objects included in the whole image data is equal to the number of target objects included in respective display areas of the plural displays, or a movement amount in which the number of target objects included in respective display areas of the plural displays is the maximum as well as the movement amount is the minimum, while moving respective display areas of the plural displays to upper, lower, right and left directions with respect to the image data, and the individual image data generation unit may generate individual image data to be displayed on the respective plural displays from the image data in respective display areas of the plural displays positioned by being moved by the movement amount found out by the overlapping improvement unit.

According to the embodiment of the present disclosure, the overlapping improvement unit may search for a movement amount in which the number of target objects included in the whole image data is equal to the number of target objects included in respective display areas of the plural displays or a combination in which the number of target objects included in respective display areas of the plural displays is the maximum as well as a enlargement ratio or a contraction ratio and the movement amount are the minimum, while enlarging or contracting the image data as well as moving respective display areas of the plural displays to upper, lower, right and left directions with respect to the enlarged or contracted image data, and the individual image data generation unit may generate individual image data to be displayed on the respective plural displays from the image data obtained after enlarged or contracted with the enlargement ratio or the contraction ratio found out by the overlapping degree improvement unit in respective display areas of the plural displays positioned by being moved by the movement amount found out by the overlapping improvement unit.

According to the embodiment of the present disclosure, there is provided an image display system including an image memory storing image data, plural displays, an individual image area determination unit determining relative positions at the time of displaying the image data based on actual positions of the plural displays, an overlapping degree improvement unit increasing an overlapping degree in which target objects included in the whole image data are included in an overlapping state in respective display areas of the plural displays while maintaining the relative positions, and an output control unit generating individual image data to be displayed on the respective plural displays in respective display areas of the plural displays in which the overlapping degree has been improved and outputting the data to the respective plural displays.

The “System” in this case indicates a logical aggregate of plural device (or function modules realizing specific functions) and it does not matter whether respective devices and function modules are included in a single casing or not.

Another embodiment of the present disclosure is directed to an image display control method including inputting image data, managing actual position information of plural displays, determining relative positions at the time of displaying the image data based on actual positions of the plural displays, increasing an overlapping degree in which target objects included in the whole image data are included in an overlapping state in respective display areas of the plural displays while maintaining the relative positions, and generating individual image data to be displayed on respective plural displays from the image data in respective display areas of the plural displays in which the overlapping degree has been improved.

Still another embodiment of the present disclosure is directed to a computer program described in a computer readable format for allowing a computer to function as an image memory storing image data, a position information management unit managing actual position information of plural displays, an individual image area determination unit determining relative positions at the time of displaying the image data based on actual positions of the plural displays, a unit for detecting target objects included in images, an overlapping degree improvement unit increasing an overlapping degree in which target objects included in the whole image data are included in an overlapping state in respective display areas of the plural displays while maintaining the relative positions and an individual image data generation unit generating individual image data to be displayed on respective plural displays from the image data in respective display areas of the plural displays in which the overlapping degree has been improved.

The computer program according to the embodiment of the present disclosure defines a computer program described in the computer readable format so as to realize given processing on the computer. In other words, when the computer program according to the embodiment of the present disclosure is installed in the computer, cooperative effects are exerted on the computer to thereby obtain the same operation and effect as the image display control device according to the embodiment of the present disclosure.

According to the technique disclosed in the present specification, it is possible to provide the excellent image display control device, the image display system, the image display control method and the computer program capable of displaying image data in landscape orientation or portrait orientation by using plural displays so that an object particularly desired to be displayed by the user such as a human face is displayed without being separated.

According to the technique disclosed in the present specification, it is possible to avoid a situation in which any of target objects is not included in individual image data displayed on respective displays while maintaining relative positions of the display areas determined based on the actual arrangement of respective displays. As the relative positions of the display areas can be kept, it is possible to give an impression that a landscape seen inside windows is changed by moving window frames to the user observing the image.

Further other features and advantages of the present disclosure will become clear by detailed explanation based on a later-described embodiment of the present disclosure and attached drawings.

### BRIEF DESCRIPTION OF THE DRAWINGS

FIG. 1A is a diagram schematically showing a configuration example of an image display system using plural displays;

FIG. 1B is a diagram schematically showing a configuration of the image display system in a master/slave format;

FIG. 2 is a view for explaining a method of displaying image data using plural displays included in the image display system;

FIG. 3 is a view for explaining a method of displaying image data using plural displays included in the image display system;

FIG. 4 is a diagram schematically showing a functional configuration of a display control unit improving an overlapping degree;

FIG. 5A is a flowchart showing processing procedures performed for improving the overlapping degree between individual image data and target objects in the display control unit;

FIG. 5B is a flowchart showing processing procedures performed for improving the overlapping degree between individual image data and target objects in the display control unit;

FIG. 6 is a view showing a state in which image data is moved while maintaining sizes and relative positions of respective display areas;

FIG. 7 is a view for explaining a significant movable range of the display areas;

FIG. 8 is a view showing a state in which respective display areas are moved in synchronization with one another on image data regenerated by enlarging original image data to search for the optimum movement amount;

FIG. 9 is a view showing a state in which respective display areas are moved in synchronization with one another on image data regenerated by contracting original image data to search for the optimum movement amount;

FIG. 10 is a diagram showing a communication sequence example for controlling image display of respective displays by using a display 102A as a master and other displays 102B and 102C as slaves;

FIG. 11 is a diagram showing a state in which image data in landscape orientation on plural displays; and

FIG. 12 is a diagram showing a state in which display images of respective displays are displaced while maintaining relative positions of respective display areas.

### DETAILED DESCRIPTION

Hereinafter, an embodiment of the present disclosure will be explained in detail with reference to the drawings.

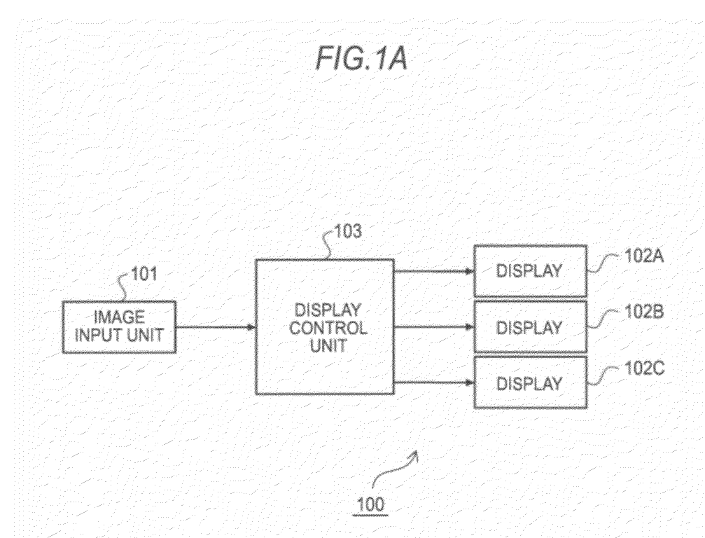

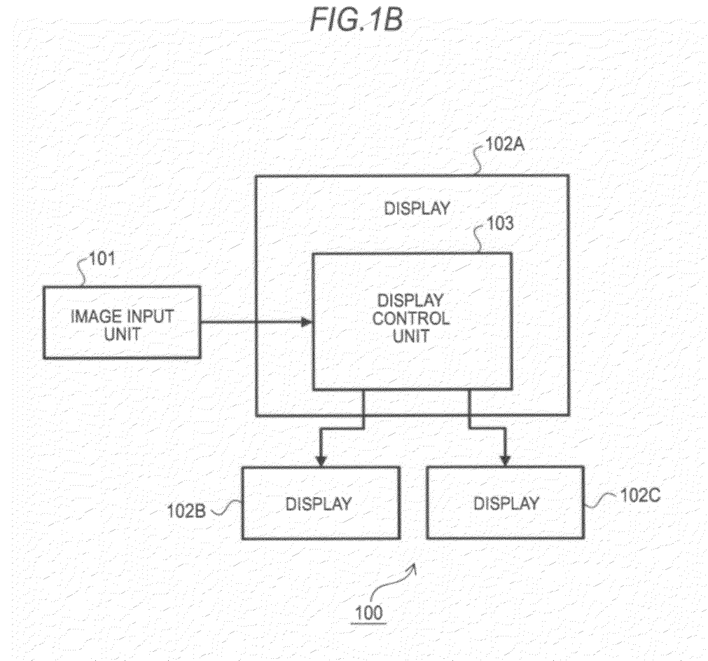

FIG. 1A schematically shows a configuration example of an image display system 100 using plural displays. The shown image display system 100 includes an image input unit 101, plural displays 102A, 102B, 102C, . . . , and a display control unit 103. The number of displays is three in the shown example for convenience of explanation, however, the number of displays is not limited to a specific number according to the gist of the technique disclosed in the specification. The number of displays may be two as well as four or more.

The image input unit 101 inputs image data to be displayed on respective displays 102A . . . . A supply source of image data may be an image reproducing device reproducing image data from recording media such as a DVD or an image generation device such as a digital camera. The image data to be inputted may be image data in landscape orientation or in portrait orientation exceeding the original aspect ratio of respective displays such as a panoramic image.

The display control unit 103 generates images to be displayed on respective displays 102A, 102B and 102C (hereinafter also referred to as “individual image data”) from the image data inputted by the image input unit 101 and controls display output of these images. A communication path between the display control unit 103 and respective displays 102A, 102B and 102C is not particularly limited.

It is also preferable that the image display system 100 is configured so that any one of displays incorporates the display control unit 103, and the display used as a master controls display of other displays as slaves. FIG. 1B shows a configuration example of the image display system 100 in a master/slave format, in which the display 102A is used as a master and other displays 102B and 102C are used as slaves. A communication path between the display 102A as the master and respective displays 102B and 102C as slaves is not particularly limited.

Subsequently, a method of displaying image data in landscape orientation or in portrait orientation exceeding the original aspect ratio such as panoramic images by using plural displays 102A . . . included in the image display system 100 will be explained. Assume that display screens of respective displays 102A, 102B and 102C are on the same plane for convenience of explanation.

Each of display 102A, 102B and 102C corresponds to a digital photo frame. The arrangement or relative positional relationship of plural displays is fixed. When the positional relationship is variable, the arrangement or relative positional relationship at the time of displaying image data is known in the present system.

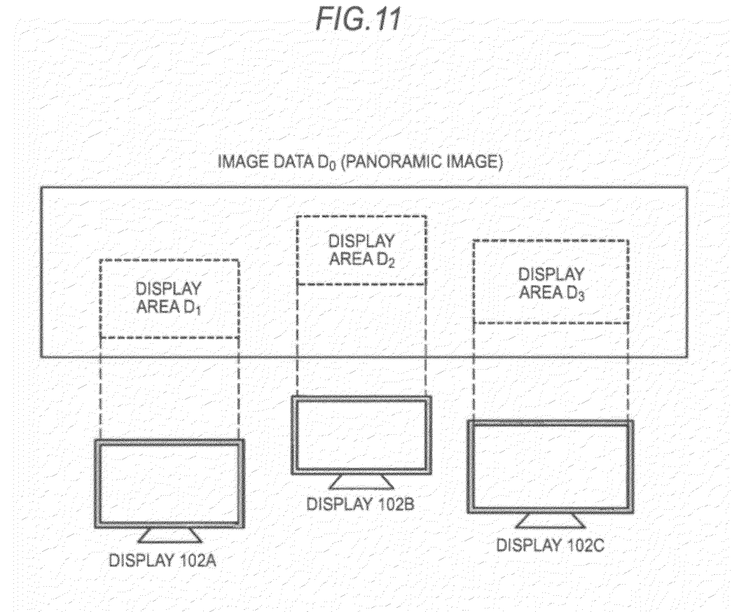

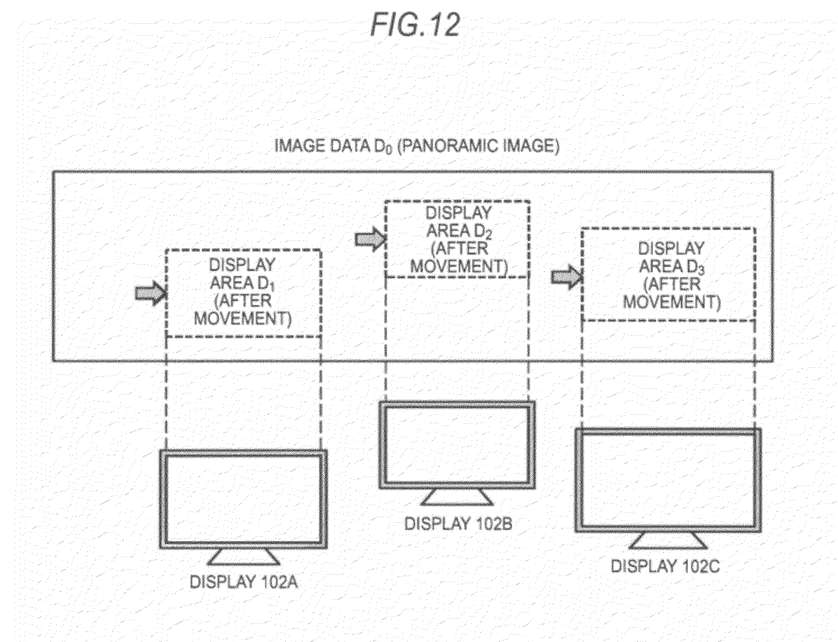

When image data in landscape orientation or in portrait orientation exceeding the original aspect ratio is displayed, relative positions of display areas of respective displays with respect to image data are determined based on the actual arrangement of respective displays 102A . . . , and individual image data of respective display areas is naturally cut out from original image data to be displayed and outputted all at once. FIG. 11 shows a state in which image data in landscape orientation is displayed by plural displays. When display areas of respective displays with respect to the original image data are moved, display images of respective displays are displaced while maintaining the relative positions of respective display areas as shown in FIG. 12. Therefore, the user observing the image can receive an impression in which the user views a landscape made of image data in landscape orientation through windows corresponding to screens of respective displays.

As can been seen from FIG. 11 as well as FIG. 12, when image data in landscape orientation or in portrait orientation exceeding the original aspect ratio is displayed by using plural displays 102A . . . in the image display system 100, there exist non-display areas not included in display areas of respective displays 102A . . . . Assuming that display areas are cut out while maintaining relative positions D₁, D₂ and D₃ determined based on the actual arrangement of respective displays 102A, 102B and 102C as described above, when a target object particularly desired to be displayed by the user overlaps the non-display area, a face image as the target object is constantly not displayed when the slide show function is activated.

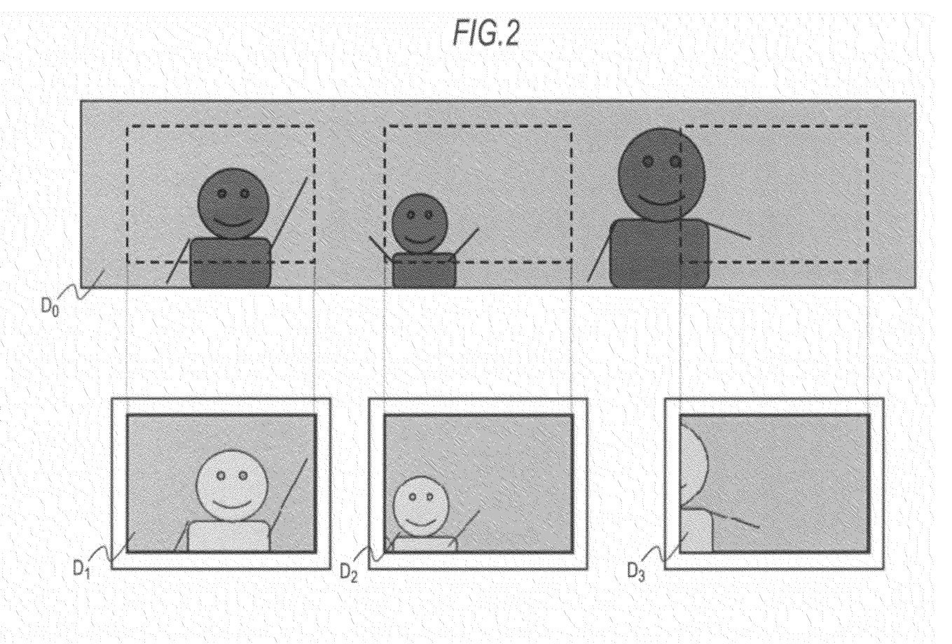

In FIG. 2, explanation will be made by using human faces as target objects as examples. In the drawing, assume that the whole area of original image data is D₀, display areas of respective displays 102A, 102B and 102C (namely, individual image data generated by the display control unit 103) are respectively D₁, D₂ and D₃. The display areas D₁, D₂ and D₃ are on the same plane. As shown in a lower part of FIG. 2, parts of the original image data D₀ are displayed on the display areas D₁, D₂ and D₃.

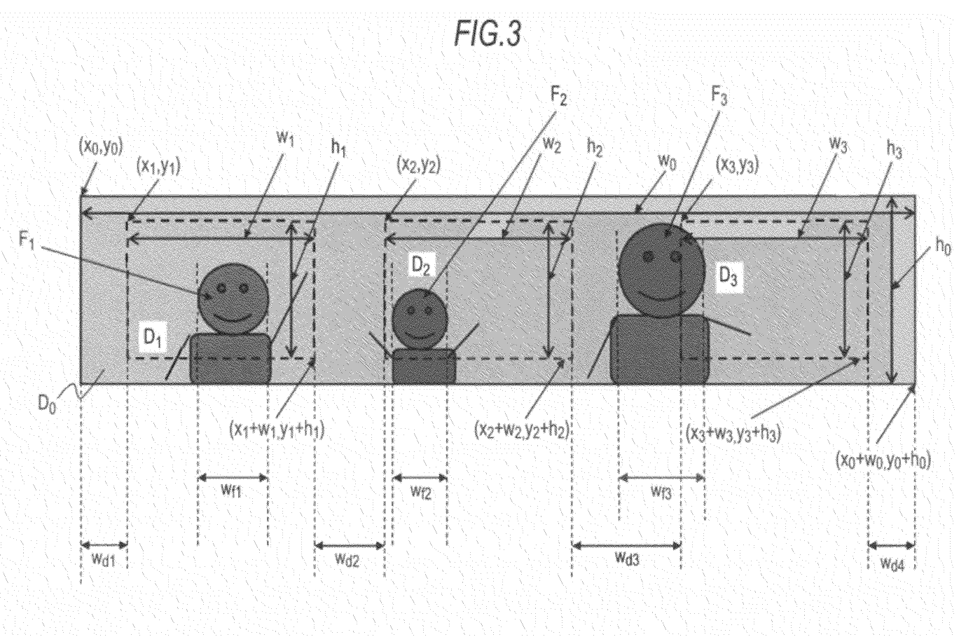

FIG. 3 shows the positional relationship between the whole area of the original image data D₀ and the display areas D₁, D₂ and D₃ of respective displays 102A, 102B and 102C. In the drawing, virtual two-dimensional coordinate system increasing from an upper left direction to a lower right direction (namely, the x-direction increases from left to right and the y-direction increases from top to bottom) is set.

The original image data D₀ is a rectangular plane with the width w₀ and the height H₀, which is defined by taking (x₀, y₀) as coordinates at the upper left and taking (x₀+w₀, y₀+h₀) as coordinates at the lower right. Here, the width corresponds to the length of the x-direction and the height corresponds to the length of the y-direction.

On the other hand, the display area D₁ of the display 102A is a rectangular plane surrounded by coordinates (x₁, y₁) to (x₁+w₁, y₁+h₁), similarly, the display area D₂ of the display 102B is a rectangular plane surrounded by coordinates (x₂, y₂) to (x₂+w₂, y₂+h₂) and the display area D₃ of the display 102C is a rectangular plane surrounded by coordinates (x₃, y₃) to (x₃+w₃, y₃+h₃). Here, w₁, h₁ are the width and the height of the display area D₁ respectively, w₂, h₂ are the width and the height of the display area D₂ respectively, and w₃, h₃ are the width and the height of the display area D₃ respectively. The rectangular planes of respective display areas D₁, D₂ and D₃ correspond to the actual arrangement and screen sizes of the displays 102A, 102B and 102C.

Additionally, the original image data D₀ includes faces of three persons F₁, F₂ and F₃ as target objects. The display control unit 103 of the image display system 100 according to the present embodiment has a face detection function detecting the number of face images as target objects, positions and sizes thereof from inputted image data. Assume that detected widths of three faces F₁, F₂ and F₃ detected by the face detection function are respectively w_{f1}, w_{f2} and w_{f3}. Also assume that widths between the display areas D₁, D₂ and D₃ (in other words, widths of non-image display areas) is w_{d1}, w_{d2} and w_{d3} respectively. The face detection function can be realized by using a face recognition technique with weak hypothesis disclosed in, for example, commonly-owned JP-A-2009-053916.

The initial state of respective display areas D₁, D₂ and D₃ is desirable to be a state in which the area ratio of the original image data included in the display areas D₁, D₂ and D₃ becomes maximum. However, it is not limited to the above depending on the setting of the display control unit 103 or other factors.

In the initial state shown in FIG. 3, the detected faces F₁ and F₂ are respectively included in the display areas D₁ and D₂ of the displays 102A and 102B respectively. On the other hand, the detected face F₃ overlaps the non-image display area having the width w_{d3} and is out of the display area D₃ of the display 102C. The detected face F₃ is constantly not displayed in the initial state even when the slide show function is activated.

Accordingly, the display control unit 103 regenerates individual image data so as to avoid a situation in which any of the target objects is not included in the individual image data displayed on respective displays 102A, 102B and 102C. It is premised that the display areas D₁, D₂ and D₃ are cut out while maintaining relative positions determined based on the actual arrangement of respective displays 102A, 102B and 102C in the regeneration processing.

As a method of regenerating individual image data, it is possible to cite an example of increasing an overlapping degree between the target objects F₁, F₂ and F₃ included in the whole original image data D₀ and target objects included in respective display areas D₁, D₂ and D₃ by each processing of, for example, position change of respective display areas D₁, D₂ and D₃ on the original image data D₀, enlargement and contraction of the original image data D₀. It is also possible to increase the overlapping degree by combining processing of changing positions of respective display areas D₁, D₂ and D₃ with processing of enlargement or contraction of the original image data D₀. In either method, the widths w_{d1}, w_{d2} and w_{d3} between respective display areas D₁, D₂ and D₃ are fixed. Note that the “overlapping degree” of objects in the present specification indicates the proportion in which target objects included in the whole original image data D₀ are included in an overlapping state in the respective display areas D₁, D₂ and D₃ cut out from the original image data D₀. Specifically, the overlapping degree can be represented by a numeric value corresponding to the proportion of the total number of target objects detected from respective display areas D₁, D₂ and D₃ with respect to the total number of target objects detected from the whole original image data D₀.

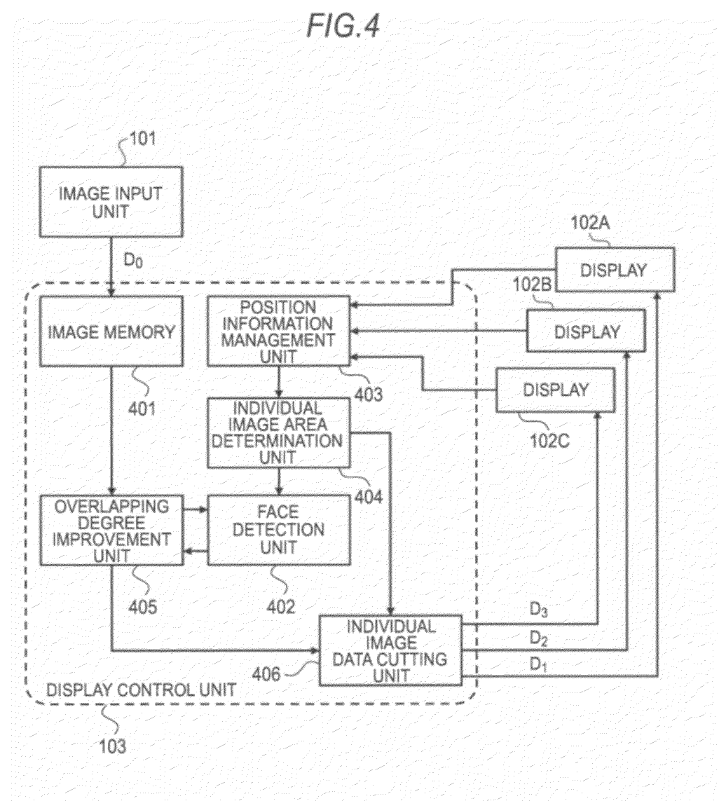

FIG. 4 schematically shows a functional configuration of the display control unit 103 performing improvement processing of the overlapping degree.

The image data D₀ inputted to the image input unit 101 is extracted in an image memory 401 and is temporarily stored therein.

Meanwhile, an position information management unit 403 manages actual position information of respective displays 102A, 102B and 102C. For example, when respective displays 102A, 102B and 102C has, for example, a position-measuring function and a communication function respectively, the position information management unit 403 makes a request for position information to respective displays 102A, 102B and 102C and acquires the position information. It is also preferable that actual position information of respective displays 102A, 102B and 102C is manually inputted to the position information management unit 403 through a not-shown user interface by the user. It is further preferable to store the position information in a nonvolatile manner in the case where actual positions of respective displays 102A, 102B and 102C are fixed as the image display system 100.

Then, an individual image area determination unit 404 determines relative positions and initial positions of the display areas D₁, D₂ and D₃ of respective displays 102A, 102B and 102C based on the actual position information of respective displays 102A, 102B and 102C. In the example shown in FIG. 3, information concerning the rectangular plane surrounded by coordinates (x₁, y₁) to (x₁+w₁, y₁+h₁) as the display area D₁ of the display 102A, the rectangular plane surrounded by coordinates (x₂, y₂) to (x₂+w₂, y₂+h₂) as the display area D₂ of the display 102B, and the rectangular plane surrounded by coordinates (x₃, y₃) to (x₃+w₃, y₃+h₃) as the display area D₃ of the display 102C is outputted from the individual image area determination unit 404.

A face detection unit 402 can perform face detection processing by using the face recognition technique with weak hypothesis disclosed in, for example, commonly-owned JP-A-2009-053916. In this case, when the face detection unit 402 receives the processed image data D₀ from an overlapping degree improvement unit 405 (in the initial state, original input image data itself is transferred), the face detection unit 402 calculates the number of detected faces N₀ by detecting faces from the whole image data as well as calculates the total number of detected faces N₁ by detecting faces from respective display areas D₁, D₂ and D₃.

The overlapping degree improvement unit 405 receives the number of detected faces N₀ in the whole image data and the total number of detected faces N₁ in respective display areas D₁, D₂ and D₃ from the face detection unit 402. When N₁ is lower than N₀, the overlapping degree improvement unit 405 determines that any of target objects is not included in individual image data of respective displays 102A, 102B and 102C, and executes processing for increasing the overlapping degree between areas of respective detected faces F₁, F₂ and F₃ and the rectangular planes of respective display areas D₁, D₂ and D₃ with respect to the original data D₀ read from the image memory 401. The processing executed by the overlapping degree improvement unit 405 for improving the overlapping degree is, for example, each processing of position change of respective display areas D₁, D₂ and D₃, enlargement and contraction of the original image data D₀, or combination of two or more of these processing methods (described later).

An individual image data cutting unit 406 regenerates individual image data for simultaneous display by cutting image data from the display areas D₁, D₂ and D₃ of the image data D₀ after the processing of improving the overlapping degree has been performed. Then, the generated individual image data is outputted to respective displays 102A, 102B and 102C.

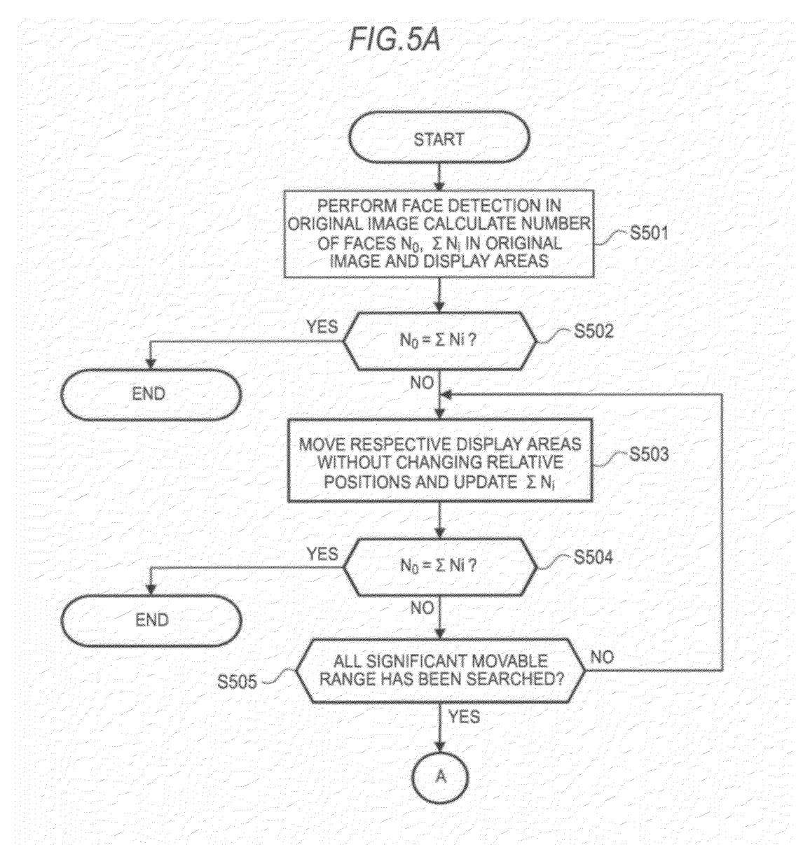

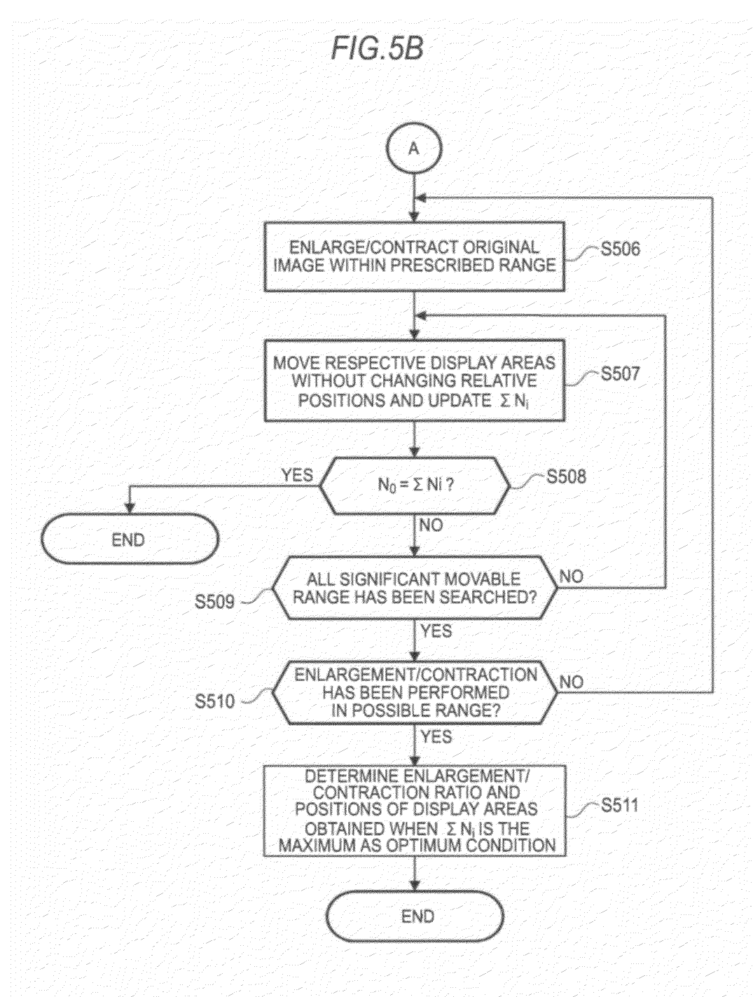

FIGS. 5A and 5B show processing procedures performed for improving the overlapping degree between the individual image data and the target objects in the display control unit 103.

First, the face detection unit 402 performs face detection processing to the original image data D₀ read from the image memory 401 and calculates the number of detected faces N₀ from the whole image data. The individual image area determination unit 404 determines relative positions and initial positions of the initial display areas D₁, D₂ and D₃ of respective displays 102A, 102B and 102C based on the actual position information of respective displays 102A, 102B and 102C. Then, the face detection unit 402 respectively performs the face detection processing to the initial display areas D₁, D₂ and D₃ in the original image data D₀ and calculates the total number ΣNᵢ (=N₁+N₂+N₃) of detected faces N₁, N₂ and N₃ included in respective display areas D₁, D₂ and D₃ (Step S501).

Next, when receiving the number of detected faces N₀ in the whole image data and the total number ΣNᵢ of detected faces N₁, N₂ and N₃ in respective display areas D₁, D₂ and D₃ from the face detection unit 402, the overlapping degree improvement unit 405 checks whether these values are equal or not (Step S502).

Here, when the values of N₀ and ΣNᵢ are equal (Yes in Step S502), it can be seen that all target objects included in the image data D₀ are displayed in any of the display areas D₁, D₂ and D₃, therefore, the present processing routine is terminated.

On the other hand, when the values of N₀ and ΣNᵢ are not equal (No in Step S502), it is determined that any of target objects is not included in the display areas D₁, D₂ and D₃. In this case, the overlapping degree improvement unit 405 regenerates image data by moving the display areas D₁, D₂ and D₃ in any of upper and lower, right and left directions with respect to image data. The face detection unit 402 calculates the number of detected faces N₀ from the whole image data after the movement as well as calculates the total number of ΣNᵢ of detected faces included in respective display areas D₁, D₂ and D₃ again (Step S503).

Here, points to keep in mind at the time of moving the display areas D₁, D₂ and D₃ with respect to the image data D₀ will be explained.

The display areas D₁, D₂ and D₃ are moved while the actual arrangement of respective displays 102A, 102B and 102C, namely, sizes and relative positions of respective display areas D₁, D₂ and D₃ with respect to the whole image data are maintained. Therefore, the image data to be displayed on respective display areas D₁, D₂ and D₃ is regenerated as if a landscape seen inside windows is changed by moving window frames (which correspond to screens of respective displays 102A, 102B and 102C).

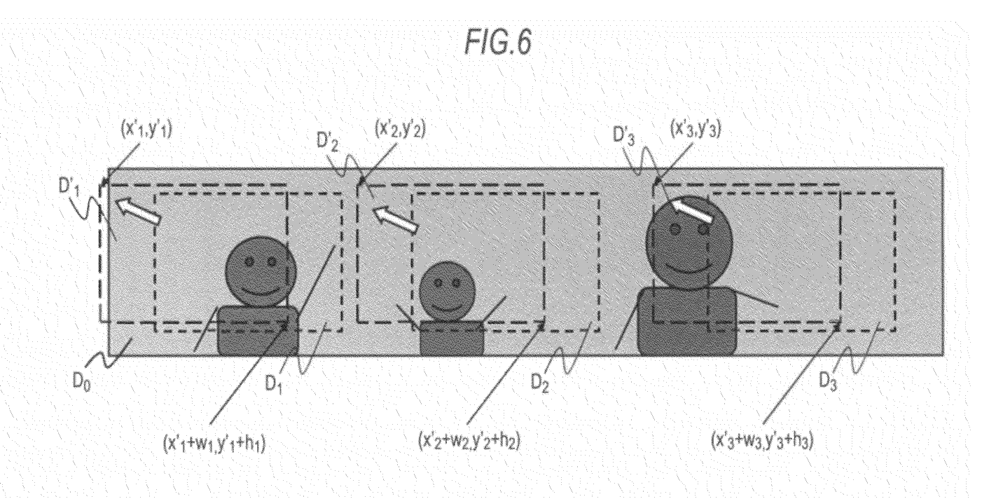

FIG. 6 shows a state in which the display areas D₁, D₂ and D₃ are moved while maintaining sizes and relative positions of respective display areas D₁, D₂ and D₃. As the sizes of the display areas D₁, D₂ and D₃ are maintained, the display area D′₁ after the movement will be a rectangular plane surrounded by coordinates (x′₁, y′₁) to (x′₁+w′₁, y′₁+h′₁), similarly, the display area D′₂ after the movement is a rectangular plane surrounded by coordinates (x′₂, y′₂) to (x′₂+w′₂, y′₂+h₂), and the display area D′₃ after the movement is a rectangular plane surrounded by coordinates (x′₃, y′₃) to (x′₃+w₃, y′₃+h₃). Additionally, the relative positions of the display areas D′₁, D′₂ and D′₃ are maintained. Therefore, x′₁=x₁₊v₁, y′₁=y₁+u₁, x′₂=x₂+v₂, y′₂=y₂+u₂, x′₃=x₃+v₃ and y′₃=y₃+u₃, and x-direction components of movement amounts of the display areas are v₁=v₂=v₃ and y-direction components are u₁=u₂=u₃.

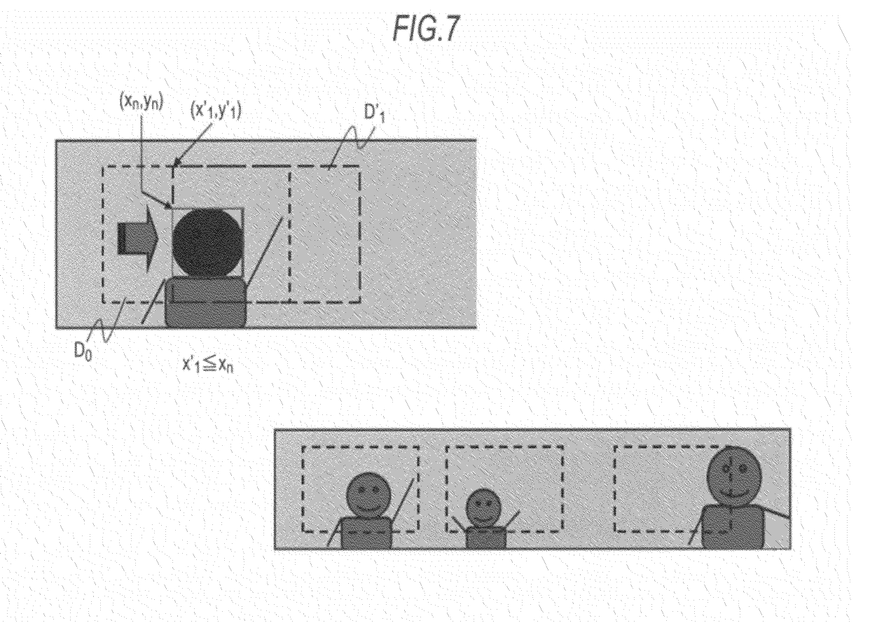

The display areas D₁, D₂ and D₃ can move within a range in which at least part of any of the display areas D₁, D₂ and D₃ overlaps the whole image data D₀. For example, in the movement in the right direction, when the leftmost x-coordinate of an area of a face positioned at the leftmost position is xₙ, there is no point in moving the leftmost x-coordinate x′₁ of the display area positioned at the left most position in the right direction beyond xₙ (see FIG. 7). The same applies to the case where the display areas D₁, D₂ and D₃ are moved to any of left, upper or lower directions. Accordingly, the overlapping degree improvement unit 405 can improve processing efficiency by performing movement processing limited to the range after determining a significant movable range such as x′₁≦Xₙ.

A measure used when the display areas D₁, D₂ and D₃ are moved once is desirably the minimum width in the widths of N₀-pieces of face areas detected by the face detection of the whole image data D₀ and the widths of non-image display areas existing between respective display areas D₁, D₂ and D₃. In the example shown in FIG. 3, it is possible to improve the processing efficiency by using w_{f2} as the measure, which is the minimum width in widths of respective detected faces w_{f1}, w_{f2}, w_{f3} and widths of non-image display areas w_{d1}, w_{d2}, w_{d3}, w_{d4}, and using a distance equal to, or more than w_{f2} as a measure of movement.

In the example shown in FIG. 3, the height of non-image display areas between the image display control devices is “0 (zero)” in movement in the y-direction. It is necessary to eliminate a case where the non-image display areas depend on only in the x-direction or the y-direction in preparation for the above case. It is naturally possible to perform detection precisely by using a distance shorter than the above as a measure of movement.

The movement of the display areas D₁, D₂ and D₃ can be started from any of upper, lower, right and left directions. However, when the non-image display areas depend on only the x-direction as the example shown in FIG. 3, the movement in the y-direction is not necessary. Conversely, when the non-image display areas depend on only the y-direction though not shown, the movement in the x-direction is not necessary.

In the case where a reference position at the time of moving the display areas D₁, D₂ and D₃ is (x, y)=(x₁, y₁), the measure of movement in the x-direction is “p”, the measure of movement in the y-direction is “q”, when “p”<“q”, the displacement of display from the state before movement will be relatively small and the sense of discomfort in appearance can be reduced by performing movement sequentially from coordinates closer to the reference position in a manner as follows:

(x′₁, y′₁)=(x₁+p, y₁), (x₁−p, y₁), (x₁, y₁+q), (x₁, y₁−q), (x₁+p, y₁−q), (x₁−p, y₁+q), (x₁+p, y₁+q), (x₁−p, y₁−q), (x₁+p×2, y₁) (x₁−p×2, y₁) . . .

The processing procedures will be explained with reference to FIGS. 5A and 5B again.

After moving the display areas D₁, D₂ and D₃ as described above, the face detection unit 402 performs face detection processing with respect to respective display areas D′₁, D′₂ and D′₃ after the movement. Then, the overlapping degree improvement unit 405 detects the number of faces included in respective display areas D′₁, D′₂ and D′₃ as N′₁, N′₂ and N′₃ and checks whether the total number ΣN′ᵢ (=N′₁+N′₂+N′₃) is equal to the number of detected faces N₀ included in the whole image data (Step S504).

It is desirable that N₀ is equal to Σ′Nᵢ, that is, it is desirable that all target objects are included in any of the display areas D′₁, D′₂ and D′₃. When N₀ is equal to Σ′Nᵢ (Yes in Step S504), the movement amount (u₁, v₁) of the display areas at this time is determined as the optimum condition and the present processing routine is terminated.

If N₀ is not equal to Σ′Nᵢ, it is desirable that Σ′Nᵢ is higher than ΣNᵢ, that is, it is desirable that the overlapping degree is improved as compared with the state before the display areas are moved. It is also preferable to find out a combination in which Σ′Nᵢ is the maximum as well as the movement amount of display areas “sqrt” (v₁²+u₁²) is the minimum as a termination condition of the present processing routine, instead of N₀=Σ′Nᵢ.

Then, the process returns to Step S503 and the movement of the display areas D₁, D₂ and D₃ to upper, lower, right and left directions is repeated within the significant movable range (No in Step S505) until the termination condition is satisfied (No in Step S504).

The significant movable range of the display areas D₁, D₂ and D₃ has been already explained with reference to FIG. 7. When the termination condition is not satisfied within the movable range even after the movement of the display areas to upper, lower, right and left directions is repeated (Yes in Step S505), subsequently, original image data is enlarged as well as contracted within a prescribed range, then, the display areas D₁, D₂ and D₃ are moved to upper, lower, right and left directions with respect to the image data in the same manner as described above to thereby search for positions where the overlapping degree is increased.

The overlapping degree improvement unit 405 enlarges or contracts image data with a given magnification (Step S506), then, moves the display regions to any of upper, lower, right and left directions to regenerate the image data (Step S507).

Then, the face detection unit 402 calculates the total number Σ′Nᵢ of detected faces included in respective display areas D′₁, D′₂ and D′₃ and checks whether Σ′Nᵢ is equal to the number of detected faces N₀ included in the whole image data or not (Step S508).

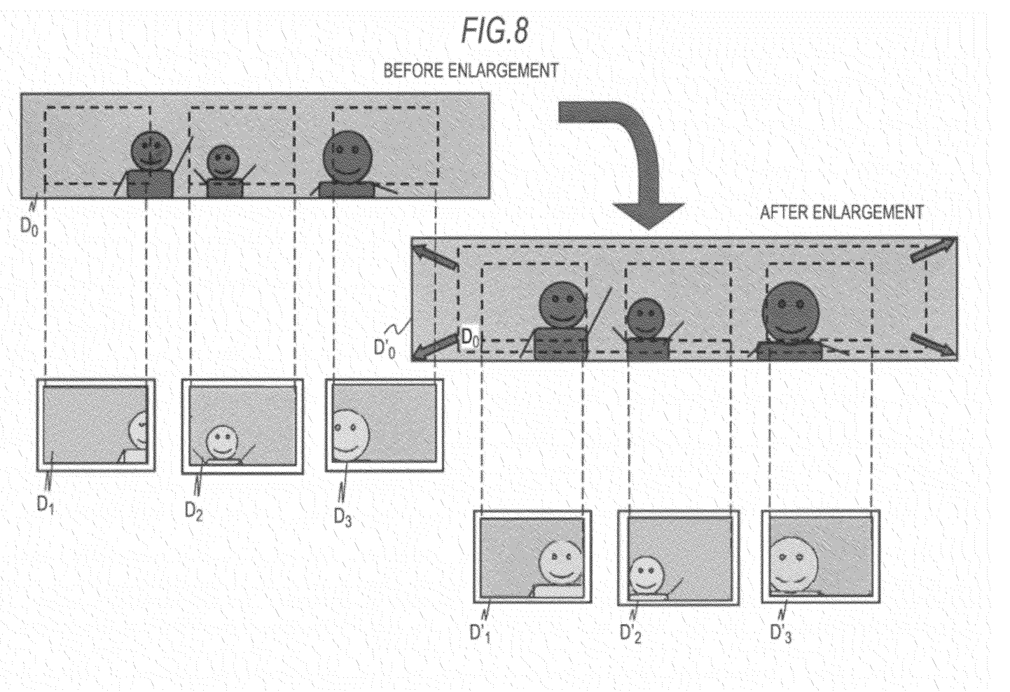

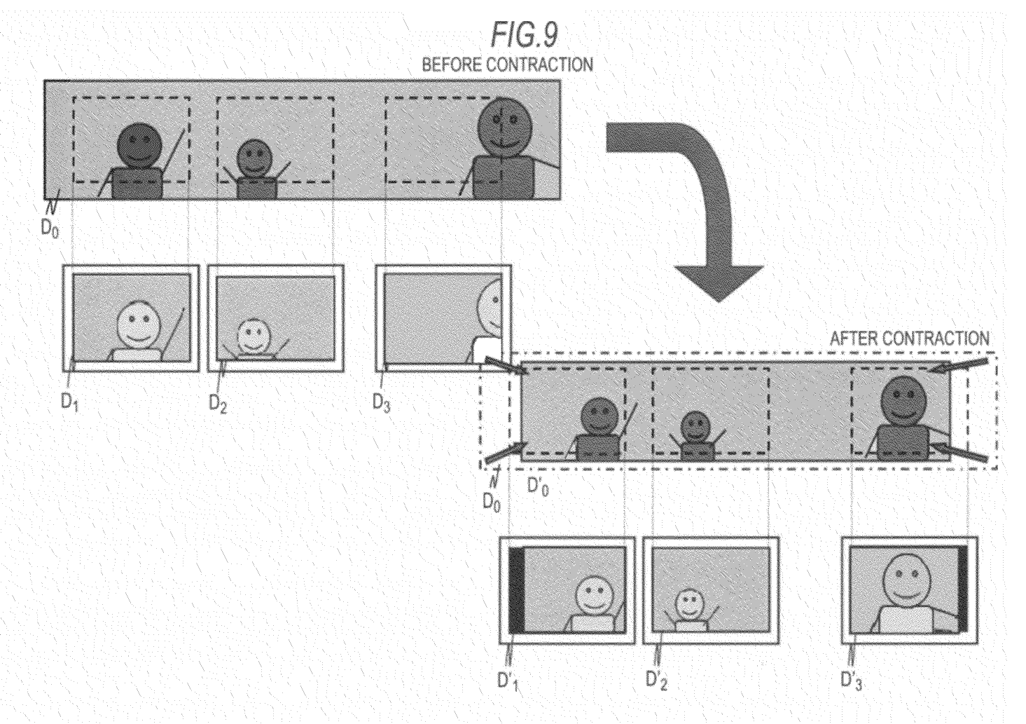

FIG. 8 shows a state in which respective display areas D′₁, D′₂ and D′₃ are moved in synchronization with one another on the image data D′₀ regenerated by enlarging the original image data D₀ to search for the optimum movement amount (u₁, v₁). The upper limit of the enlargement ratio may be set, for example, so that any of the width or the height of an area of the detected face after the enlargement is longer than any of the width or the height of the display area. FIG. 9 shows a state in which respective display areas D′₁, D′₂ and D′₃ are moved in synchronization with one another on the image data D′₀ regenerated by contracting the original image data D₀ to search for the optimum movement amount (u₁, v₁). The upper limit of the contraction ratio may be set, for example, so that both of the width and the height of an area of the detected face after the contraction are not smaller than the width and the height at least necessary for the face detection processing. Please refer to the above for points to keep in mind at the time of moving the display areas D₁, D₂ and D₃.

It is desirable that N₀ is equal to Σ′Nᵢ, namely, all target objects are included in any of the display areas D′₁, D′₂ and D′₃. When N₀ is equal to Σ′Nᵢ (Yes in Step S508), the present processing routine is terminated. It is possible to terminate the present processing routine by determining the enlargement ratio or the contraction ratio of the image data and the movement amount (u₁, v₁) of the display areas D₁, D₂ and D₃ obtained at the time of finding out a combination in which Σ′Nᵢ is the maximum and the movement amount of “sqrt” (v₁²+u₁²) of display areas D₁, D₂ and D₃ is the minimum as well as the enlargement ratio or the contraction ratio of the image data D₀ is the minimum as the optimum conditions, instead of N₀=Σ′Nᵢ.

The process returns to Step S507 and the movement of the display areas D₁, D₂ and D₃ to upper, lower, right and left directions is repeated in the significant movable range (No in Step S509) until the termination condition is satisfied (No in Step S508).

When the termination condition is not satisfied within the movable range even after the movement of the display areas D₁, D₂ and D₃ to upper, lower, right and left directions is repeated (Yes in Step S509), the process returns to Step S506 (No in Step S510) and the image data is enlarged or contracted by changing the magnification and the movement of the display areas D₁, D₂ and D₃ to upper, lower, right and left directions is repeated in the significant movable range in the same manner as described above (No in Step S509).

When the termination condition is not satisfied even after the original image data is enlarged/contracted within the predetermined range (Yes in Step S510), the present processing routine is terminated by determining the enlargement ratio or the contraction ratio of the image data and the movement amount (u₁, v₁) of the display areas D₁, D₂ and D₃ obtained when the total number Σ′Nᵢ of detected faces included in the display areas D′₁, D′₂ and D′₃ is the maximum during execution of the processing flow as the optimum conditions (Step S511).

There may be a case where a face not to be displayed on any of display areas of the displays even when the overlapping degree between the individual image data and target objects is increased by performing the processing procedures shown in FIGS. 5A and 5B. In such case, it is possible to move coordinates of the display areas D₁, D₂ and D₃ of respective displays 102A, 102B and 102C with time by a given activation (for example, from right to left, left to right) in synchronization with one another. According to the process, it is possible to display all faces at least on any of the display areas D₁, D₂ and D₃ at any point of time though there inevitably exists a face not to be displayed in each point of time.

When coordinates of the display areas D₁, D₂ and D₃ are moved with time as described above, Step S503 and Step S507 in which faces are detected while moving the display areas D₁, D₂ and D₃ in FIGS. 5A and 5B are not necessary. The significant movable range used when moving the display areas D₁, D₂ and D₃ has been explained with reference to FIG. 7.

As shown in FIG. 1B, it is possible that any one of displays incorporates the display control unit 103 and the display as the master performs processing procedures shown in FIGS. 5A and 5B to control display of other displays as slaves.

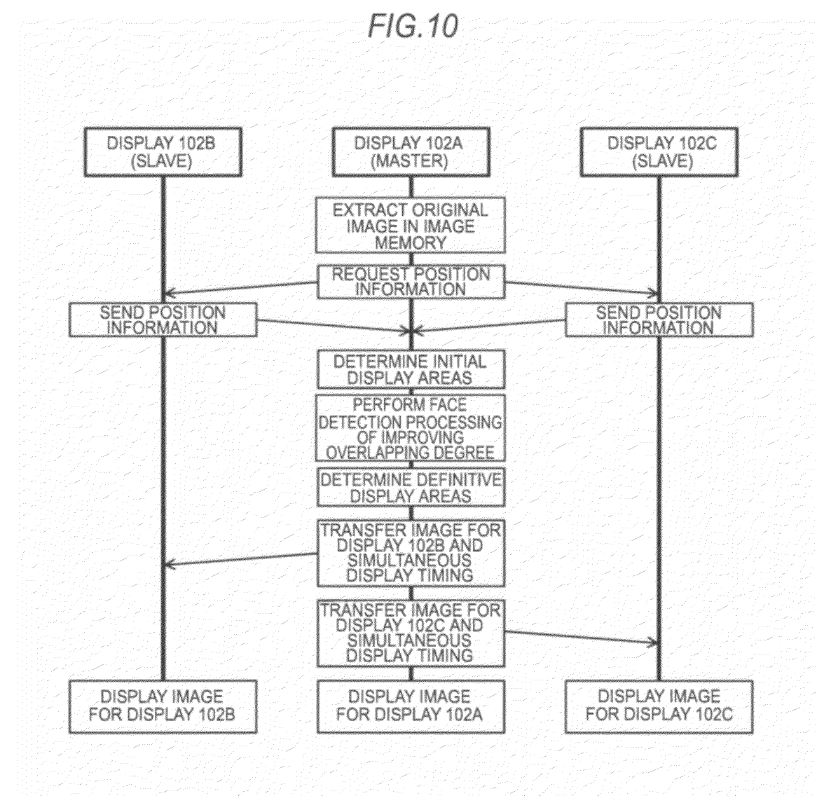

FIG. 10 shows a communication sequence example for controlling image display of respective displays by using the display 102A as the master and using other displays 102B and 102C as slaves. In the communication sequence example, the number of slaves is two, however, the number of slaves is not limited to a specific number according to the gist of the technique disclosed in the specification, and the number of slave may be one as well as three or more.

The display 102A as the master extracts the inputted image data in the image memory 401.

Next, the display 102A requests position information with respect to respective displays 102B and 102C as slaves. In response to this, respective displays 102A and 102C send position information of the displays themselves. It is also preferable that respective displays 102B and 102C include the position-measuring function and send position information obtained by measuring positions. It is further preferable that respective displays 102A and 102C have the fixed position information, store the information in the nonvolatile manner and send the stored position information.

The display 102A determines initial position information of the display areas D₁, D₂ and D₃ of respective displays 102A, 102B and 102C based on position information sent from the displays 102B and 102C by the individual image area determination unit 404.

Next, the display 102A performs processing for improving the overlapping degree by the overlapping degree improvement unit 405 in accordance with processing procedures shown in FIGS. 5A and 5B. Then, the enlargement ratio or the contraction ratio of the original image data D₀ as well as definitive positions of the display areas D₁, D₂ and D₃ are determined so that all target objects included in the original image data D₀ are displayed on any of the display areas D₁, D₂ and D₃ or the number of target objects displayed on the display areas D₁, D₂ and D₃ is the maximum.

Next, the display 102A cuts the individual image data for simultaneous display from the display area D₂ of the image data D₀ after the processing for improving the overlapping degree has been performed by the individual image data cutting unit 406, and transfers the data to the display 102B as the slave with timing information of simultaneous display. The display 102A cuts individual image data for simultaneous display from the display area D₃ of the image data D₀ after the processing for improving the overlapping degree has been performed by the individual image data cutting unit 406, and transfers the data to the display 102C as the slave with timing information of simultaneous display.

Then, respective displays 102A, 102B and 102C simultaneously displays individual image data cut out from the respective display areas D₁, D₂ and D₃ of the image data D₀ to which enlargement or contraction processing has been appropriately performed.

There may be a case where a face not to be displayed on any of display areas of the displays even when the overlapping degree between the individual image data and target objects is increased by performing the processing procedures shown in FIGS. 5A and 5B. It is possible to move coordinates of the display areas D₁, D₂ and D₃ of respective displays 102A, 102B and 102C with time by a given activation (for example, from right to left, left to right) in synchronization with one another, though not shown in FIG. 10. According to the process, it is possible to display all faces at least on any of the display areas D₁, D₂ and D₃ at any point of time though there inevitably exists a face not to be displayed in each point of time.

The technique disclosed in the present specification has been explained in detail with reference to specific embodiments. However, it should be understood by those skilled in the art that various modifications alterations may occur within the scope of the gist of the technique disclosed in the specification.

In the present specification, the embodiment applied to the system including plural digital photo frames has been explained, however, the technique disclosed in the present specification can be also applied to various types of multi-displays including plural displays.

In the present specification, the embodiment in which the image in landscape orientation is displayed on plural displays has been chiefly explained, however, the technique disclosed in the present specification can be also applied to a case in which an image in portrait orientation is displayed on plural displays.

In the present specification, the embodiment in which human faces are used as target objects has been chiefly explained, however, the technique disclosed in the present specification can be also applied to cases in which various objects such as regions other than the human face, animals, goods are used as target subjects.

In short, the present disclosure has been disclosed in a form of exemplification and the described contents of the present specification should not been limitedly interpreted. The appended claims should be taken in consideration for deciding the gist of the present technique.

The present disclosure contains subject matter related to that disclosed in Japanese Priority Patent Application JP 2011-094550 filed in the Japan Patent Office on Apr. 20, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image display control device comprising:
an image memory storing image data;
a position information management unit managing actual position information of plural displays;
an individual image area determination unit determining relative positions at the time of displaying the image data based on actual positions of the plural displays;
a unit for detecting target objects included in images;
an overlapping degree improvement unit increasing an overlapping degree in which target objects included in the whole image data are included in an overlapping state in respective display areas of the plural displays while maintaining the relative positions; and
an individual image data generation unit generating individual image data to be displayed on respective plural displays from the image data in respective display areas of the plural displays in which the overlapping degree has been improved.

2. The image display control device according to claim 1,
wherein the overlapping degree improvement unit searches for a movement amount in which the number of target objects included in the whole image data is equal to the number of target objects included in respective display areas of the plural displays, or a movement amount in which the number of target objects included in respective display areas of the plural displays is the maximum as well as the movement amount is the minimum, while moving respective display areas of the plural displays to upper, lower, right and left directions with respect to the image data, and
the individual image data generation unit generates individual image data to be displayed on the respective plural displays from the image data in respective display areas of the plural displays positioned by being moved by the movement amount found out by the overlapping improvement unit.

3. The image display control device according to claim 1,
wherein the overlapping improvement unit searches for a movement amount in which the number of target objects included in the whole image data is equal to the number of target objects included in respective display areas of the plural displays or a combination in which the number of target objects included in respective display areas of the plural displays is the maximum as well as a enlargement ratio or a contraction ratio and the movement amount are the minimum, while enlarging or contracting the image data as well as moving respective display areas of the plural displays to upper, lower, right and left directions with respect to the enlarged or contracted image data, and
the individual image data generation unit generates individual image data to be displayed on the respective plural displays from the image data obtained after enlarged or contracted with the enlargement ratio or the contraction ratio found out by the overlapping degree improvement unit in respective display areas of the plural displays positioned by being moved by the movement amount found out by the overlapping improvement unit.

4. An image display system comprising:
an image memory storing image data;
plural displays;
an individual image area determination unit determining relative positions at the time of displaying the image data based on actual positions of the plural displays;
an overlapping degree improvement unit increasing an overlapping degree in which target objects included in the whole image data are included in an overlapping state in respective display areas of the plural displays while maintaining the relative positions; and
an output control unit generating individual image data to be displayed on the respective plural displays in respective display areas of the plural displays in which the overlapping degree has been improved and outputting the data to the respective plural displays.

5. An image display control method comprising:
inputting image data;
managing actual position information of plural displays;
determining relative positions at the time of displaying the image data based on actual positions of the plural displays;
increasing an overlapping degree in which target objects included in the whole image data are included in an overlapping state in respective display areas of the plural displays while maintaining the relative positions; and
generating individual image data to be displayed on respective plural displays from the image data in respective display areas of the plural displays in which the overlapping degree has been improved.

6. A computer program described in a computer readable format for allowing a computer to function as:
an image memory storing image data;
a position information management unit managing actual position information of plural displays;
an individual image area determination unit determining relative positions at the time of displaying the image data based on actual positions of the plural displays;
a unit for detecting target objects included in images;
an overlapping degree improvement unit increasing an overlapping degree in which target objects included in the whole image data are included in an overlapping state in respective display areas of the plural displays while maintaining the relative positions; and
an individual image data generation unit generating individual image data to be displayed on respective plural displays from the image data in respective display areas of the plural displays in which the overlapping degree has been improved.
